(19) United States
(12) Patent Application Publication
(10) Pub. No.: US 2015/0367788 A1
(43) Pub. Date: Dec. 24, 2015

(54) Method for Producing a Seal

(71) Applicant: Henkel AG & Co. KGaA, Duesseldorf (DE)

(72) Inventors: Jozef Hudina, Ketsch (DE); Uwe Weinbrecht, Mannheim (Friedrichsfeld) (DE); Dirk Reitenbach, Sinsheim (DE); Eric Grulich, Leimen (DE)

(21) Appl. No.: 14/837,042

(22) Filed: Aug. 27, 2015

Related U.S. Application Data
(63) Continuation of application No. PCT/EP2014/053305, filed on Feb. 20, 2014.

(30) Foreign Application Priority Data
Feb. 27, 2013 (DE) 102013203302.8

(51) Int. Cl. B60R 13/06; B05C 9/14; B05D 3/02; B05D 5/00; B62D 25/02

(52) U.S. Cl. CPC B60R 13/06; B05D 5/00; B62D 25/02; B05D 3/0281; B05C 9/14

(57) ABSTRACT

The invention relates to a method for producing a seal (7), in which a sealing compound (6) is applied to a workpiece (11) by means of a dosing device (4) with a relative movement (10) between the workpiece (11) and the dosing device (4), and in which an application region of the workpiece (11) to which the sealing compound (6) is applied is heated by means of a heating device (2) prior to the application of the sealing compound (7) with a relative movement (10) between the workpiece (11) and the heating device (2).

The present invention relates to a method for sealing adhesive and sealing points, in particular in the motor vehicle field. Applications that shall be mentioned include hem flange bonding and sealing, which are also known by the technical terms of fine seam sealing, rough seam sealing and structural bonded joints on auto bodies and the lining of attachment parts, for example.

In the case of hem flange sealing in motor vehicle construction, for example, a bead of a sealing adhesive or sealer is typically placed over the outwardly open region of the hem in the form of a curable material, which in a first setting process of the sheet metal gels in the region of the settable compound and is then fully cured in a downstream setting process. In particular PVC is used as the settable compound here.

DE102006006848A1, for example, discloses a method and a device for producing a bonded hem joint of workpieces, wherein a bonding adhesive is applied in a line into an open hem of a first workpiece and, essentially at the same time, at least one sealing adhesive is additionally applied in a further line next to the line of the bonding adhesive, which serves to seal the bonded hem joint when the hem is closed around the edge of a further workpiece. In many instances, however, air is trapped beneath the sealing adhesive in the hem flange, which expands during subsequent setting and forms outwardly visible blisters. The blisters not only adversely affect the appearance, but also form weak spots permitting corrosive attacks in the seal.

To eliminate this problem, EP1041130A1 discloses a method for sealing auto body sections, in particular for hem flange sealing vehicle attachment parts, such as doors, tailgates or engine hoods, or sliding roof panels. The method is based on a two-step pre-cross-linking process of the sealing compound in the auto body-in-white. In a first step, the surface of a UV-active sealing compound is pre-crosslinked by UV irradiation, and in a second, directly following step, the hem flange adhesive and the sealing compound are partially set under the action of heat. This is in particular intended to prevent a seal from breaking open as a result of a trapped air bubble. However, this method may be complex and incur additional costs under some circumstances.

Moreover, EP1186642A1 discloses special two-component systems, which are suitable for lining, hem flange bonding and sealing auto body sections, which are suitable in particular for hem flange bonding of vehicle attachment parts, and a method for sealing an auto body section. Within the predefined cycle time, the described two-component systems reach the necessary touch dryness for installing the attachment parts on the auto body and, after passing through the cataphoretic dip-coating stage, the strength and dimensional accuracy necessary for the manufacturing process as a result of the two-step cross-linking process of the sealing compound. This is in particular intended to prevent a seal from breaking open as a result of a trapped air bubble. However, this method may be very complex and/or incur added costs under some circumstances. The special two-component system used here results in additional costs and may make handling more difficult.

It is therefore the object of the present invention to provide a method for sealing adhesive and sealing points, which reduces blistering as a result of trapped gases or liquids.

The object is achieved by the features of the main claim.

Advantageous embodiments of the invention are described in the dependent claims.

The basic idea of the invention is the use of a method in which a sealing compound is applied to an application region of a workpiece by means of a dosing device with a relative movement between the workpiece and the dosing device, and in which the application region of the workpiece to which the sealing compound is applied is heated by means of a heating device with a relative movement between the workpiece and the heating device prior to the application of the sealing compound, wherein the application of the sealing compound is preferably carried out by way of the dosing device in the heated state of the application region.

The method according to the invention is preferably used in the motor vehicle industry, for example when sealing or leak-proofing seams of hem flanges in motor vehicle construction. A sealing compound, in particular in the form of a curable material, is typically placed over the outwardly open region of a hem, for example in the form of a bead, which after application is cured in one or more setting steps, in particular by the action of heat. The sealing compound may comprise a plastisol as a base ingredient. These plastisols can in particular be PVC plastisols, as they are described in DE1769325A or DE2200022A, for example. The use of other suitable sealing compounds is also conceivable, of course, in particular those that are already used for sealing purposes in motor vehicles.

As described at the outset, problems as a result of trapped air bubbles are to be expected in particular in the described seals, in particular in seam seals. While known methods are aimed at covering trapped air bubbles with a particularly hard sealing compound, for example, so that these bubbles can no longer break through the sealing compound, the method according to the invention is intended to reduce the trapped air volume and/or remaining moisture so as to prevent further problems, such as the same breaking through the seal. The method according to the invention is thus directed to minimizing or even eliminating the source of the defect per se, instead of concealing the symptoms of the same. After full implementation of the novel method, the expenditure of carrying out quality controls of the seam seal can thus be significantly reduced. Moreover, complex manual reworking of formerly faulty sections in seam sealing can be dispensed with. When using the novel method, the manufacturing procedure can be significantly simplified and the quality increased. The novel method may furthermore be implemented in existing lines without major investments.

The essential core of the method according to the invention provides for the workpiece, which is to say the hem flange of a motor vehicle door, for example, to be heated by a heating device immediately prior to the application of the sealing compound in the application region, which is to say the application site of the sealing compound, in such a way the air volume remaining there within the hem flange is heated so as to achieve a change in air density. The density of the remaining air volume during this heating therefore decreases since a portion of the air volume thus heated escapes in the direction of the outwardly open region of the hem. Thereafter, while the workpiece is still in a heated and not entirely cooled state, the sealing compound is applied in the region of the application site of the sealing compound via the dosing device. The application preferably takes place at a point in time at which the air volume is still heated so much that it is in a state of lower density and a portion of the air volume has escaped. The application of the sealing compound thus takes place while the remaining air volume is still in the heated state. The remaining air volume is thus encased by the sealing compound in the state of lower density. The encasement preferably takes place in such a way that no air from outside can find its way to the remaining air volume encased by the sealing compound.

The heating device is preferably configured, and the procedure of the method is preferably designed, in such a way that heating of the application region takes place u a temperature in the range of 80° C. to 180° C. Within this range, the air volume remaining in the hem can be sufficiently heated to achieve the described change in density. Moreover, burdening of the application region itself or an impairment of an adhesive and/or sealant that has already been used within the hem can be precluded or at least minimized. As an alternative or in addition, it has proven advantageous in particular to configure and match the heating device and the dosing device to each other, and to design the procedure of the method, in such a way that the application region is heated prior to the application of the sealing compound in such a way that the subsequent application of the sealing compound is made to this application region, wherein the application region has a temperature in the range of 80° C. to 180° C. during application. It can thus be ensured that the temperature of the air volume remaining in the hem is still sufficiently heated, and still has the desired density, when that the sealing compound is being applied. When the first range of the temperature to which the application region is heated is used, it has proven to be particularly useful for the sealing compound to be applied to the application region at a point in time or during a time interval when which the temperature of the application region is only slightly lower. A temperature difference of a few ° C., for example of 5° C., may prove useful for this purpose.

By suitably selecting the process parameters, the method according to the invention thus allows the remaining air volume in the hem flange to preferably be lowered sufficiently through defined heating of the workpiece in the application region, which is to say in the region of the application site of the sealing compound, immediately prior to the application of the sealing compound so that the risk of destroying or deforming the sealing compound due to a change in density of the air volume, for example during later heating of the workpiece, in particular in a temperature control furnace, is minimized or reduced. By suitably selecting the parameters, the method according to the invention additionally allows pre-gelling of the sealing compound to be dispensed with, which is intended to ensure reliable sealing in known methods.

If additionally to the air volume, or in addition or as an alternative thereto, residual moisture should remain in the hem flange, the same can likewise be removed, or at least reduced, through use of the heating device by heating the application region, which is to say the application site of the sealing compound immediately prior to the application of the sealing compound.

As described at the outset, the workpiece, more precisely the application site of the sealing compound, is heated by a relative movement between the workpiece and the heating device. According to the invention, the sealing compound is likewise applied by a relative movement between the workpiece and, in this case, the dosing device. It has proven particularly advantageous for this purpose for the heating device to preferably lead the dosing device at a defined and constant distance.

In an advantageous refinement of the invention, the relative movement takes place at least regionally between the workpiece on the one hand and a sealing unit, composed of the heating device and the dosing device, on the other hand. For example, the dosing device and the heating device can thus undergo a relative movement with or in relation to the workpiece, in particular at least regionally or sectionally, together as a sealing unit in a primary relative movement or basic direction. A movement of the workpiece, a movement of the sealing unit, or a movement of the workpiece and of the sealing unit is conceivable.

A sealing unit shall in particular be understood to mean a unit which provides for the heating device and the dosing device to be fixedly connected, so that the heating device leads the dosing device, preferably at a defined and constant distance during the relative movement, so as to ensure that the application region is heated immediately prior to the application of the sealing compound. It is also conceivable, of course, for the distance to be adjustable, in particular using suitable mechanical, electromechanical or pneumatically operated actuating means.

On the other hand, the sealing unit may also be understood to mean a heating device and a dosing device as two elements that are entirely separated or separate from each other, however which carry out the same, or essentially the same, relative movement with respect to the workpiece, so as to ensure that the application site of the sealing compound is heated immediately prior to the application of the sealing compound.

It is furthermore conceivable that, while the heating device and the dosing device to essentially undergo the same primary relative movement with respect to the workpiece, one of the two devices mentioned, or both, are subject to further relative movements with respect to the workpiece, in addition to the primary relative movement. For example, the heating device and/or the dosing device can undergo one or more secondary relative movements, in addition to the primary relative movement, during which the application of the sealing compound can also take place, for example. For example, in particular the heating device and/or the dosing device can undergo or be subject to a circular or meander-shaped secondary relative movement around the primary relative movement.

The workpiece may be moved on the one hand, or the heating device and the dosing device, or both devices together as the sealing unit, may be moved on the other hand. It is possible, on the one hand, for the heating device and the dosing device, or both devices together as the sealing unit, to be stationary or, on the other hand, for the workpiece to be stationary or to be moved with the moving part in deviating directions in each case.

In an advantageous refinement, a primary relative movement is carried out in a range of 100 mm/s to 350 mm/s, preferably in a range of 150 mm/s to 300 mm/s, so that the shortest possible residence times within the heating area of the heating device result for the workpiece, in particular in a range of 0.1 to 0.6 s, for example in particular also due to a suitable configuration of the heating device. It is conceivable, for example, that the sealing unit, comprising the heating device and, at a fixed distance therefrom, the dosing device, is moved at a feed rate of 250 mm/s, for example, relative to the workpiece, which in this case is not moved, for example.

The method according to the invention is preferably used for a bonded hem joint in auto body sheets, preferably for joining inner panels to outer panels, for example on doors and/or lids of a motor vehicle.

In one advantageous refinement, an inductively heatable workpiece, in particular made of steel or aluminum, is used, wherein the heating device comprises at least one inductor for inductively heating the workpiece. Preferably, inductors are used which operate at a frequency in the range of 70 kHz to 200 kHz, particularly preferably in a range of 150 kHz to 180 kHz. Moreover, it may be advantageous to use inductors having an output in a range of 4 kW to 20 kW, particularly preferably in a range of 8 kW to 18 kW, in the shown exemplary embodiment of 18 kW, for example. In an advantageous embodiment, the inductor is additionally liquid-cooled, in particular by way of a water emulsion.

In one advantageous refinement, during heating the distance from the heating device to the workpiece, in particular to the application region to be heated, in particular from the heat outputting region of the heating device or the heat triggering region of the heating device or the effective surface of the heating device for heating or the region of the heating device located opposite the application region, in particular of the inductor, is in a range of 0.2 cm to 2 cm, particularly preferably in a range of 0.4 cm to 0.8 cm, in the shown exemplary embodiment it is 0.5 cm, for example.

In an advantageous refinement of the method, it is provided that, during the relative movement, the heating device simultaneously leads the dosing device, or the nozzle of the dosing device, for applying the sealing compound at a time interval in the range of 0.1 s to 6 s. This may in particular be advantageous since existing hardware already in use on the manufacturing line may also be used for the novel method without any major expenditure, for example in that the respective application robot for sealing, in particular for seam sealing, may also guide the heating device for heating, comprising in particular the inductor. By using these advantageous, preferably short trailing times, cooling of the application region after heating can be avoided, so that the sealing compound can be applied while the temperature of the application region is still sufficient.

In one advantageous refinement of the method, it is provided that, in particular the relative movement is selected, and the heating device is configured, in such a way that the application region is located within an effective heating surface or an effective heating area of the heating device during a time period in the range of 0.1 s to 0.8 s, preferably within 0.1 s to 0.3 s. This may be understood to mean the area or the space around the heating device which influences the temperature within the meaning of a temperature increase, which is to say heating of the application region of the workpiece. In this way, for example excessive heating and damage to the workpiece, or impairment of the workpiece, can be avoided.

In particular for connecting the heating device to existing manufacturing lines, it may furthermore prove to be advantageous to equip the heating device with a bus interface, in particular a Profibus, or a real time Ethernet interface.

A further basic idea of the invention is the use of a sealing unit for producing a seal on or at a workpiece, comprising a dosing device for applying a sealing compound and a heating device for heating the workpiece prior to the application of the sealing compound. Such a sealing unit is suited for the above-described method, for example. The above-described advantageous embodiments of the dosing device, heating device and also of the sealing unit can be used as preferred embodiments here as well and thus supplement this device-related section.

A further advantage is that the dosing device and the heating device are connected in such a way that a defined distance is maintained between the dosing device and the heating device during a relative movement between the sealing unit and the workpiece. This may be achieved, for example, by configuring the sealing unit as described above within the scope of the method. In particular, a fixed connection of the heating device and the dosing device may be provided, so that the heating device leads the dosing device at a fixed distance during the relative movement, so as to ensure that the application region is heated immediately prior to the application of the sealing compound. It is also conceivable, of course, for the distance to be adjustable, in particular using suitable mechanical, electromechanical or pneumatically operated actuating means.

In one advantageous refinement, the heating device of the sealing unit comprises at least one inductor for inductively heating an inductively heatable workpiece. The inductor may in particular have above-mentioned preferred characteristics in terms of output and frequency. The inductor may additionally be liquid-cooled, in particular by way of a water emulsion. It has proven particularly advantageous to use a circular inductor or a linear inductor or a polygonal inductor. In one advantageous refinement, it is additionally or alternatively provided to design the inductor to be exchangeable.

A further advantage is the use of one or more multi-axis robots, at the arm or arms of which the dosing device and the heating device are arranged. In particular for connecting the heating device to existing manufacturing lines, it may furthermore be advantageous to equip the robot or the heating device and/or the dosing device itself with a bus interface, in particular a Profibus, or a real time Ethernet interface.

The method according to the invention and a sealing unit according to the invention are described hereafter in detail by way of example based on a preferred exemplary embodiment.

### BRIEF DESCRIPTION OF THE DRAWINGS

FIG. 1 shows a sectional view through a workpiece and a side view of a sealing unit according to the invention for carrying out a method according to the invention; and

FIG. 2 shows a front view of the sealing unit in FIG. 1 while the method according to the invention is carried out.

### DETAILED DESCRIPTION

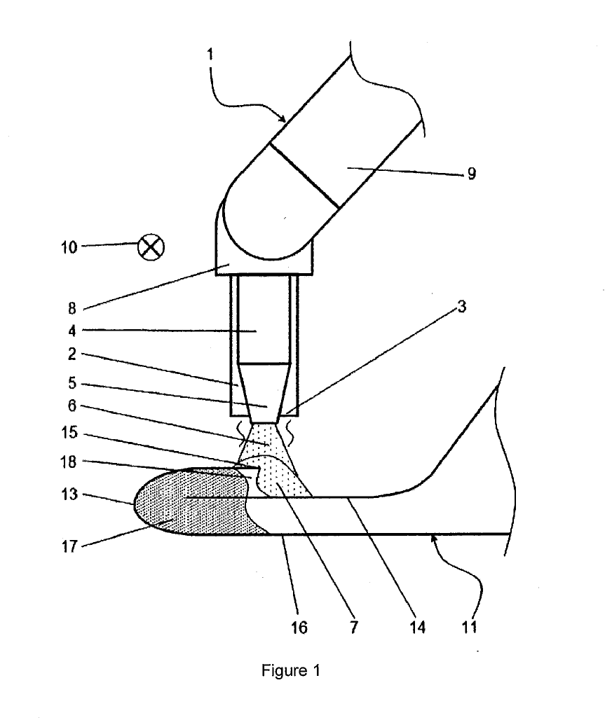

FIG. 1 shows a sectional view through a workpiece 11 and a side view of a sealing unit 1 according to the invention for carrying out a method according to the invention for producing a seal 7. The sealing unit 1 and the method are used for hem flange sealing in motor vehicle construction in the shown exemplary embodiment. The workpiece 11 is an outer panel 12 of a motor vehicle door, which is bent around an inner panel 14 by way of a hem 13. A hem flange adhesive 17 is provided in the region of the hem 13 and is applied prior to hemming in such a quantity that, ideally, it fills the entire hemming region. A sealing compound 6 is applied over the outer hemming region and a free edge 15 of the outer panel 16 by way of a spray method, the sealing compound covering the outer hemming region, and in particular the free edge 15, as a seal 7. As shown in FIG. 1, however, a cavity may result in the edge-side region of the hem 13 during production of the hem flange, in particular due to an insufficient amount of hem flange adhesive 17, the cavity resulting in entrapped air 18 when the sealing compound 6 is applied, which could expand and break open the seal 7. The method according to the invention and the application unit 1 according to the invention are used to prevent this.

The sealing unit 1 for producing a seal 7 on the workpiece 11 comprises a dosing device 4 for applying the sealing compound 6 and a heating device 2 for heating the application region of the workpiece 11, to which the sealing compound 6 is to be applied, immediately prior to the application of the sealing compound 6. The dosing device 4 comprises an application nozzle 5 for applying the sealing compound 6 to the outer hemming region, wherein the application of the sealing compound 6 is carried out by means of a relative movement between the dosing device 4 and the workpiece 11. In the shown exemplary embodiment, the workpiece 11 is held by a robotic arm (not shown) in the shown application position for this purpose, wherein a further multi-axis robotic arm 9 is provided, on which the dosing device 4 is installed via a holding device 8 and by means of which the dosing device 4 can be moved relative to the workpiece 11 in a movement direction 10 to apply the sealing compound 6. As an alternative or in addition, however, it is also conceivable for the workpiece 11 to be in particular movable relative to the application unit 1 by means of the robotic arm addressed above.

The dosing device 4 and in particular the application nozzle 5 are configured in such a way that not only different sealing compounds 6 are applied, but also different application types can be selected. The sealing compound 6 can be applied as a bead or sprayed on, for example; however, application by means of thin jet spraying, as shown, using an application jet is also conceivable.

Additionally, the heating device 2 for heating the application region of the workpiece 11 is provided in order to process and influence potential entrapped air 18 in such a way that impairment of the applied sealing compound 6 is minimized. The heating device is likewise installed on the robotic arm 9 via the holding device 8. The heating device 2 and the dosing device 4 are arranged in such a way that the application region for the sealing compound 6 on the workpiece 11 is heated immediately prior to the application of this sealing compound 6. The heating device 2 comprises an inductor 3 for this purpose, for inductively heating the application region of the workpiece 11. The output of the inductor 3 is 18 kW, and the frequency is 180 kHz. In addition, a liquid cooling system (not shown) is provided for cooling the inductor 3, wherein the cooling liquid used is a water emulsion. The sealing unit 1 is arranged and is moved relative to the workpiece 11 in the movement direction 10 in such a way that, during heating of the workpiece 11, the inductor 3 is located at a constant distance of approximately 0.5 cm from the outer surface of the workpiece 11, which is to say the side of the outer panel 16 facing the inductor 3 in the region of the free edge 15. The inductor 3 is additionally selected, and the sealing unit 1 is moved relative to the workpiece 11 at a preferably constant speed in the movement direction 10, in such a way that the application region of the workpiece 11 is located within the area of the inductor 3 which is effective for heating the application region only for a time period of approximately 0.3 s, or better said, that each site of the application region intended to be heated is exposed to heating by the heating device 2 for only approximately 0.3 s. The sealing unit 1 is moved relative to the workpiece 11, which in this case is not moved, at a feed rate of approximately 250 mm/s. The workpiece 11 is thus heated directly in the application region with the aid of the inductor 3, whereby indirectly an air volume present there is also heated. The workpiece 11 is heated to a temperature of approximately 140° C., which results in an identical or at least similar temperature of the air volume. Due to heating, the density of the remaining air volume decreases since a portion of the heated air volume escapes in the direction of the region of the hem 13 which is still open in the direction of the outer hemming region and the free edge 15. If, in addition to this air volume, residual moisture should remain in the cavity, the same can likewise be removed, or at least reduced, by heating the application region, which is to say the application site of the sealing compound 6 immediately prior to the application of the sealing compound 6. Thereafter, while the workpiece 11 is still in the heated and not entirely cooled state, the sealing compound 6 is applied to the application region via the dosing device 4 and forms the shown seal 7.

The distance between the dosing device 4 and the heating device 2 on the holding device 8 and the speed of the sealing unit 1 in the movement direction 10 are set such that the heating device 2, or rather the area of the inductor 3 effective for heating the application region, simultaneously leads the dosing device 2 during the movement of the sealing unit 1 in the movement direction 10 at an interval of 0.3 s here. In this way, cooling of the application region after heating can be avoided, so that the sealing compound 6 can be applied while the temperature of the application region is still sufficient. The sealing compound 6 is thus applied while the remaining air volume is still heated, so that the remaining air volume is encased by the sealing compound 6 in a state of lower density. Reduced entrapped air 18 thus remains and is enclosed by the seal 7, wherein the seal 7 can be prevented from breaking open as a result of expansion of the reduced air volume remaining in the entrapped air 18 through later method steps. The encasement by the seal 7 preferably takes place in such a way that no air from outside can penetrate the entrapped air 18.

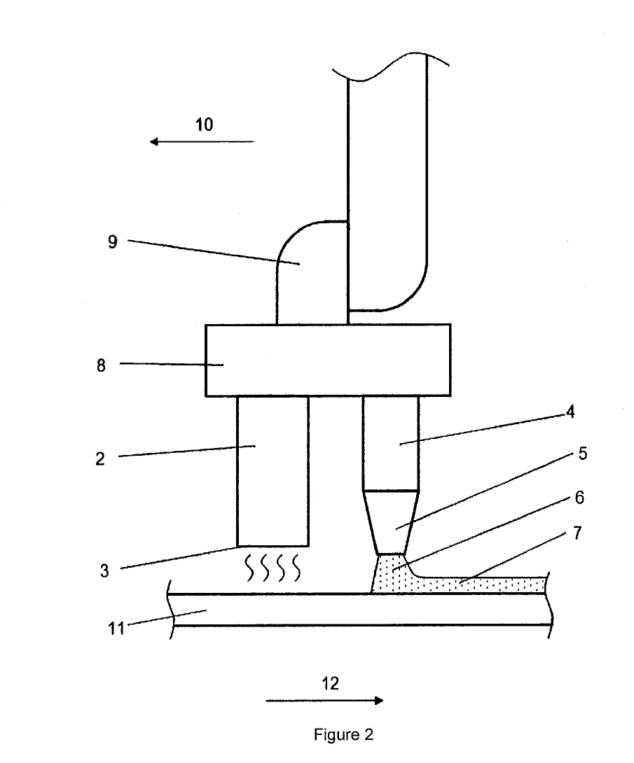

FIG. 2 shows a top view of the end face of the hem 13 and a corresponding front view of the sealing unit 1 of FIG. 1 while the method according to the invention for producing a seal 7 is carried out. It is apparent that both the heating device 2 comprising the inductor 3 and the dosing device 4 comprising the application nozzle 5 are attached together on the multi-axis robotic arm 9 via the holding device 8. The heating device 2 and the dosing device 4 are thus moved as one unit in the movement direction 10, wherein the heating device 2 and the dosing device 4 are rigid and fixed in relation to each other during displacement in terms of their positions, so as to be able to maintain a defined distance between the heating device 2 and the dosing device 4 during a relative movement between the sealing unit 1 and the workpiece 11. The holding device 8 can moreover be configured so that a fixation of these components for the method is made possible on the one hand, and on the other hand so that the distance between the heating device 2 and the dosing device 4 is variable using a linear drive or similar mechanical aids, in particular so as to adapt the sealing unit, for example when the workpiece 11 changes, and design it for flexible use.

During a movement of the sealing unit 1 in the movement direction 10 relative to the workpiece 11, the application region of the workpiece 11 intended for application of the sealing compound 7 can be heated immediately prior to the application of the sealing compound 7 by way of the inductor 3 in such a way that the air volume remaining there within the hem flange is heated so as to achieve an above-described change in air density. If, in addition to this air volume, or as an alternative thereto, residual moisture should remain in the hem flange, the same can likewise be removed, or at least reduced, through use of the heating device 2 by heating the application region immediately prior to the application of the sealing compound 6.

It goes without saying that, as addressed above, an alternative or additional movement of the workpiece in a movement direction 12 is also possible. As a result of the constant movement of the sealing unit 1 and the defined distance between the heating device 2 and the application unit 4, an application of the sealing compound 7, for example using the above-described parameters, by means of the application jet via the application nozzle 5 in the still heated, and not yet fully cooled state of the application region the sealing compound 7 is applied. The sealing compound 7 is thus applied while the remaining air volume is still heated, which is thus encased by the seal 7 in a state of lower density. The method according to the invention is thus directed to minimizing or even eliminating the source of the defect per se, instead of concealing the symptoms of the same. In this way, after fully implementing the novel method, the expenditure for carrying out quality control of the seam seal can be significantly reduced, and complex manual reworking of formerly faulty sections in the seam seal can be dispensed with.

### LIST OF REFERENCE NUMERALS

1 sealing unit
2 heating device
3 inductor
4 dosing device
5 application nozzle
6 sealing compound
7 seal
8 holding device
9 robotic arm
10 movement direction of application unit
11 workpiece
12 movement direction of workpiece
13 hem
14 inner panel
15 free edge
16 outer panel
17 hem flange adhesive
18 trapped air

1. A method for producing a seal, wherein a sealing compound is applied to a workpiece by means of a dosing device with a relative movement between the workpiece and the dosing device, and wherein an application region of the workpiece to which the sealing compound is applied is heated by means of a heating device prior to the application of the sealing compound with a relative movement between the workpiece and the heating device.

2. The method according to claim 1, wherein the relative movement takes place at least regionally between the workpiece and the heating device together with the sealing unit.

3. A seal of a hem joint on an auto body sheet made by the method of claim 1.

4. An inner or outer panel of a motor vehicle door or a motor vehicle roof comprising the seal of the hem joint of claim 3.

5. The method according to claim 1, wherein the workpiece is inductively heatable and the heating device comprises at least one inductor to inductively heat the workpiece.

6. The method according to claim 1, wherein, during the relative movement, the heating device simultaneously leads the dosing device or a nozzle of the dosing device by an interval in the range of 0.1 seconds to 6 seconds.

7. A sealing unit for producing a seal on a workpiece, comprising a dosing device for applying a sealing compound and a heating device for heating the workpiece or an application region of the workpiece prior to the application of the sealing compound.

8. The sealing unit according to claim 7, wherein the dosing device and the heating device can be connected to each other to maintain a predefined distance between the dosing device and the heating device during relative movement between the sealing unit and the workpiece.

9. The sealing unit according to claim 7, wherein the heating device comprises at least one inductor for inductively heating an inductively heatable workpiece.

10. The sealing unit according to claim 7, wherein the dosing device and the heating device are arranged on an arm) of a multi-axis robot.

11. A method for producing a seal, comprising:
providing a dosing device, a heating device, a sealing compound and a workpiece;
heating an application region of the workpiece with the heating device wherein there is relative movement between the workpiece and heating device; and
applying the sealing compound to the heated application region of the workpiece with the dosing device to form the seal, wherein there is relative movement between the workpiece and the dosing device.
